(19) United States
(12) Patent Application Publication
(10) Pub. No.: US 2012/0239689 A1
(43) Pub. Date: Sep. 20, 2012

(54) COMMUNICATING TIME-LOCALIZED METADATA

(75) Inventors: Joonas Asikainen, Zurich (CH); Brian Kenneth Vogel, Santa Clara, CA (US)

(73) Assignee: ROVI TECHNOLOGIES CORPORATION, Santa Clara, CA (US)

(21) Appl. No.: 13/049,537

(22) Filed: Mar. 16, 2011

(51) Int. Cl. G06F 17/30

(52) U.S. Cl. 707/770; 707/E17.014

(57) ABSTRACT

A system includes a processor that retrieves, from a first database, a portion of content associated with time-localized metadata. The time-localized metadata and a tag mode identifier are retrieved from a second database. A tag mode associated with the portion of content is determined based on the time-localized metadata and/or the tag mode identifier. The portion of content and/or the time-localized metadata are transmitted to a user device based on the tag mode. In some embodiments, a reconstruction mode associated with the portion of content is determined based on the time-localized metadata and/or a reconstruction mode identifier. The portion of content, the time-localized metadata, attribute information, and/or mapping information are transmitted to the user device based on the reconstruction mode.

### BACKGROUND

1. Field

Example aspects of the present invention generally relate to metadata, and more particularly to time-localized metadata.

2. Related Art

Metadata is generally understood to mean data that describes other data, such as the contents of digital recordings. For instance, metadata can be information relating to an audio track of a CD, DVD or other type of digital file, such as title, artist, album, track number, and other information, in the audio track itself. Such metadata is associated with the audio track in the form of stored tags. Time-localized metadata is metadata that describes, or is applicable to, a portion of content, where the metadata includes a time span during which the metadata is applicable.

As the length and complexity of content increase, it may be the case that corresponding metadata is applicable to a portion of the content, rather than to the content in its entirety. It would be useful to have time-localized metadata describe a portion of, for example, a streaming audio or video track. One technical challenge is how to efficiently and effectively communicate time-localized metadata.

### BRIEF DESCRIPTION

The example embodiments described herein provide systems, methods, and computer program products for communicating time-localized metadata. The system includes a processor that retrieves, from a first database, a portion of content associated with time-localized metadata. The time-localized metadata and a tag mode identifier are retrieved from a second database. A tag mode associated with the portion of content is determined based on the time-localized metadata and/or the tag mode identifier. The portion of content and/or the time-localized metadata are transmitted to a user device based on the tag mode.

In another aspect, the processor determines a reconstruction mode associated with the portion of content based on the time-localized metadata and/or a reconstruction mode identifier. The portion of content, the time-localized metadata, attribute information, and/or mapping information are transmitted to the user device based on the reconstruction mode.

Further features and advantages, as well as the structure and operation, of various example embodiments of the present invention are described in detail below with reference to the accompanying drawings.

### BRIEF DESCRIPTION OF THE DRAWINGS

The features and advantages of the example embodiments presented herein will become more apparent from the detailed description set forth below when taken in conjunction with the drawings.

FIG. 1 is a diagram of a system for tagging, communicating, and receiving data including time-localized metadata in which some embodiments are implemented.

FIG. 2 is a timeline representing a portion of content that has been tagged with time-localized metadata.

FIG. 3 is a flowchart diagram showing an exemplary procedure for tagging content with time-localized metadata.

FIG. 4 is a flowchart diagram showing an exemplary procedure for transmitting, to a user device, content that has been tagged with time-localized metadata.

FIG. 5 is a flowchart diagram showing an exemplary procedure for receiving time-localized metadata.

FIG. 6 is a block diagram of a computer for use with various example embodiments of the invention.

### DETAILED DESCRIPTION

### I. Overview

The example embodiments of the invention presented herein are directed to systems, methods, and computer program products for utilizing time-localized metadata in an environment using consumer devices in conjunction with a remote content database. This description is not intended to limit the application of the example embodiments presented herein. In fact, after reading the following description, it will be apparent to one skilled in the relevant art(s) how to implement the following example embodiments in alternative environments, such as a services-based environment, a web services-based environment, etc.

### II. Definitions

Some terms are defined below for easy reference. However, it should be understood that the defined terms are not rigidly restricted to their definitions. A term may be further defined by its use in other sections of this description.

“Album” means a collection of tracks. An album is typically originally published by an established entity, such as a record label (e.g., a recording company such as Warner Brothers and Universal Music).

“Attribute” means a metadata item corresponding to a particular characteristic of a portion of content. Each attribute falls under a particular attribute category. Examples of attribute categories and associated attributes for music include cognitive attributes (e.g., simplicity, storytelling quality, melodic emphasis, vocal emphasis, speech like quality, strong beat, good groove, fast pace), emotional attributes (e.g., intensity, upbeatness, aggressiveness, relaxing, mellowness, sadness, romance, broken heart), aesthetic attributes (e.g., smooth vocals, soulful vocals, high vocals, sexy vocals, powerful vocals, great vocals), social behavioral attributes (e.g., easy listening, wild dance party, slow dancing, workout, shopping mall), genre attributes (e.g., alternative, blues, country, electronic/dance, folk, gospel, jazz, Latin, new age, R&B/soul, rap/hip hop, reggae, rock), sub genre attributes (e.g., blues, gospel, motown, stax/memphis, philly, doo wop, funk, disco, old school, blue eyed soul, adult contemporary, quiet storm, crossover, dance/techno, electro/synth, new jack swing, retro/alternative, hip hop, rap), instrumental/vocal attributes (e.g., instrumental, vocal, female vocalist, male vocalist), backup vocal attributes (e.g., female vocalist, male vocalist), instrument attributes (e.g., most important instrument, second most important instrument), etc.

Examples of attribute categories and associated attributes for video content include genre (e.g., action, animation, children and family, classics, comedy, documentary, drama, faith and spirituality, foreign, high definition, horror, independent, musicals, romance, science fiction, television, thrillers), release date (e.g., within past six months, within past year, 1980s), scene type (e.g., foot-chase scene, car-chase scene, nudity scene, violent scene), commercial break attributes (e.g., type of commercial, start of commercial, end of commercial), actor attributes (actor name, scene featuring actor), soundtrack attributes (e.g., background music occurrence, background song title, theme song occurrence, theme song title), interview attributes (e.g., interviewer, interviewee, topic of discussion), etc.

Other attribute categories and attributes are contemplated and are within the scope of the embodiments described herein.

“Audio Fingerprint” (e.g., “fingerprint”, “acoustic fingerprint”, “digital fingerprint”) is a digital measure of certain acoustic properties that is deterministically generated from an audio signal that can be used to identify an audio sample and/or quickly locate similar items in an audio database. An audio fingerprint typically operates as a unique identifier for a particular item, such as, for example, a CD, a DVD and/or a Blu-ray Disc. An audio fingerprint is an independent piece of data that is not affected by metadata. Rovi™ Corporation has databases that store over 25 million unique fingerprints for various audio samples. Practical uses of audio fingerprints include without limitation identifying songs, identifying records, identifying melodies, identifying tunes, identifying advertisements, monitoring radio broadcasts, monitoring multipoint and/or peer-to-peer networks, managing sound effects libraries and identifying video files.

“Audio Fingerprinting” is the process of generating an audio fingerprint. U.S. Pat. No. 7,277,766, entitled “Method and System for Analyzing Digital Audio Files”, which is herein incorporated by reference, provides an example of an apparatus for audio fingerprinting an audio waveform. U.S. Pat. No. 7,451,078, entitled “Methods and Apparatus for Identifying Media Objects”, which is herein incorporated by reference, provides an example of an apparatus for generating an audio fingerprint of an audio recording.

“Blu-ray” and “Blu-ray Disc” mean a disc format jointly developed by the Blu-ray Disc Association, and personal computer and media manufacturers including Apple, Dell, Hitachi, HP, JVC, LG, Mitsubishi, Panasonic, Pioneer, Philips, Samsung, Sharp, Sony, TDK and Thomson. The format was developed to enable recording, rewriting and playback of high-definition (HD) video, as well as storing large amounts of data. The format offers more than five times the storage capacity of conventional DVDs and can hold 25 GB on a single-layer disc and 800 GB on a 20-layer disc. More layers and more storage capacity may be feasible as well. This extra capacity combined with the use of advanced audio and/or video codecs offers consumers an unprecedented HD experience. While current disc technologies, such as CD and DVD, rely on a red laser to read and write data, the Blu-ray format uses a blue-violet laser instead, hence the name Blu-ray. The benefit of using a blue-violet laser (about 405 nm) is that it has a shorter wavelength than a red or infrared laser (about 650-780 nm). A shorter wavelength makes it possible to focus the laser spot with greater precision. This added precision allows data to be packed more tightly and stored in less space. Thus, it is possible to fit substantially more data on a Blu-ray Disc even though a Blu-ray Disc may have substantially similar physical dimensions as a traditional CD or DVD.

“Chapter” means an audio and/or video data block on a disc, such as a Blu-ray Disc, a CD or a DVD. A chapter stores at least a portion of an audio and/or video recording.

“Compact Disc” (CD) means a disc used to store digital data. The CD was originally developed for storing digital audio. Standard CDs have a diameter of 740 mm and can typically hold up to 80 minutes of audio. There is also the mini-CD, with diameters ranging from 60 to 80 mm. Mini-CDs are sometimes used for CD singles and typically store up to 24 minutes of audio. CD technology has been adapted and expanded to include without limitation data storage CD-ROM, write-once audio and data storage CD-R, rewritable media CD-RW, Super Audio CD (SACD), Video Compact Discs (VCD), Super Video Compact Discs (SVCD), Photo CD, Picture CD, Compact Disc Interactive (CD-i), and Enhanced CD. The wavelength used by standard CD lasers is about 650-780 nm, and thus the light of a standard CD laser typically has a red color.

“Consumer,” “data consumer,” and the like, mean a consumer, user, client, and/or client device in a marketplace of products and/or services.

“Content,” “media content,” “content data,” “multimedia content,” “program,” “multimedia program,” and the like are generally understood to include music albums, television shows, movies, games, videos, and broadcasts of various types. Similarly, “content data” refers to the data that includes content. Content (in the form of content data) may be stored on, for example, a Blu-Ray Disc, Compact Disc, Digital Video Disc, floppy disk, mini disk, optical disc, micro-drive, magneto-optical disk, ROM, RAM, EPROM, EEPROM, DRAM, VRAM, flash memory, flash card, magnetic card, optical card, nanosystems, molecular memory integrated circuit, RAID, remote data storage/archive/warehousing, and/or any other type of storage device.

“Content information,” “content metadata,” and the like refer to data that describes content and/or provides information about content. Content information may be stored in the same (or neighboring) physical location as content (e.g., as metadata on a music CD or streamed with streaming video) or it may be stored separately.

“Content source” means an originator, provider, publisher, distributor and/or broadcaster of content. Example content sources include television broadcasters, radio broadcasters, Web sites, printed media publishers, magnetic or optical media publishers, and the like.

“Content stream,” “data stream,” “audio stream,” “video stream,” “multimedia stream” and the like means data that is transferred at a rate sufficient to support such applications that play multimedia content. “Content streaming,” “data streaming,” “audio streaming,” “video streaming,” “multimedia streaming,” and the like mean the continuous transfer of data across a network. The content stream can include any form of content such as broadcast, cable, Internet or satellite radio and television, audio files, video files.

“Data correlation,” “data matching,” “matching,” and the like refer to procedures by which data may be compared to other data.

“Data object,” “data element,” “dataset,” and the like refer to data that may be stored or processed. A data object may be composed of one or more attributes (“data attributes”). A table, a database record, and a data structure are examples of data objects.

“Database” means a collection of data organized in such a way that a computer program may quickly select desired pieces of the data. A database is an electronic filing system. In some implementations, the term “database” may be used as shorthand for “database management system.”

“Data structure” means data stored in a computer-usable form. Examples of data structures include numbers, characters, strings, records, arrays, matrices, lists, objects, containers, trees, maps, buffer, queues, matrices, look-up tables, hash lists, booleans, references, graphs, and the like.

“Device” means software, hardware or a combination thereof. A device may sometimes be referred to as an apparatus. Examples of a device include without limitation a software application such as Microsoft Word™, a laptop computer, a database, a server, a display, a computer mouse, and a hard disk.

“Digital Video Disc” (DVD) means a disc used to store digital data. The DVD was originally developed for storing digital video and digital audio data. Most DVDs have substantially similar physical dimensions as compact discs (CDs), but DVDs store more than six times as much data. There is also the mini-DVD, with diameters ranging from 60 to 80 mm. DVD technology has been adapted and expanded to include DVD-ROM, DVD-R, DVD+R, DVD-RW, DVD+RW and DVD-RAM. The wavelength used by standard DVD lasers is about 605-650 nm, and thus the light of a standard DVD laser typically has a red color.

“Fuzzy search,” “fuzzy string search,” and “approximate string search” mean a search for text strings that approximately or substantially match a given text string pattern. Fuzzy searching may also be known as approximate or inexact matching. An exact match may inadvertently occur while performing a fuzzy search.

“Link” means an association with an object or an element in memory. A link is typically a pointer. A pointer is a variable that contains the address of a location in memory. The location is the starting point of an allocated object, such as an object or value type, or the element of an array. The memory may be located on a database or a database system. “Linking” means associating with, or pointing to, an object in memory.

“Metadata” means data that describes data. More particularly, metadata may be used to describe the contents of recordings. Such metadata may include, for example, a track name, a song name, artist information (e.g., name, birth date, discography), album information (e.g., album title, review, track listing, sound samples), relational information (e.g., similar artists and albums, genre) and/or other types of supplemental information such as advertisements, links or programs (e.g., software applications), and related images. Other examples of metadata are described herein. Metadata may also include a program guide listing of the songs or other audio content associated with multimedia content. Conventional optical discs (e.g., CDs, DVDs, Blu-ray Discs) do not typically contain metadata. Metadata may be associated with a recording (e.g., a song, an album, a video game, a movie, a video, or a broadcast such as a radio, television or Internet broadcast) after the recording has been ripped from an optical disc, converted to another digital audio format and stored on a hard drive. Metadata may be stored together with, or separately from, the underlying data that is described by the metadata.

“Network” means a connection between any two or more computers, which permits the transmission of data. A network may be any combination of networks, including without limitation the Internet, a network of networks, a local area network (e.g., home network, intranet), a wide area network, a wireless network and a cellular network.

“Occurrence” means a copy of a recording. An occurrence is preferably an exact copy of a recording. For example, different occurrences of a same pressing are typically exact copies. However, an occurrence is not necessarily an exact copy of a recording, and may be a substantially similar copy. A recording may be an inexact copy for a number of reasons, including without limitation an imperfection in the copying process, different pressings having different settings, different copies having different encodings, and other reasons. Accordingly, a recording may be the source of multiple occurrences that may be exact copies or substantially similar copies. Different occurrences may be located on different devices, including without limitation different user devices, different MP3 players, different databases, different laptops, and so on. Each occurrence of a recording may be located on any appropriate storage medium, including without limitation floppy disk, mini disk, optical disc, Blu-ray Disc, DVD, CD-ROM, micro-drive, magneto-optical disk, ROM, RAM, EPROM, EEPROM, DRAM, VRAM, flash memory, flash card, magnetic card, optical card, nanosystems, molecular memory integrated circuit, RAID, remote data storage/archive/warehousing, and/or any other type of storage device. Occurrences may be compiled, such as in a database or in a listing.

“Pressing” (e.g., “disc pressing”) means producing a disc in a disc press from a master. The disc press preferably produces a disc for a reader that utilizes a laser beam having a wavelength of about 650-780 nm for CD, about 605-650 nm for DVD, about 405 nm for Blu-ray Disc or another wavelength as may be appropriate.

“Program,” “multimedia program,” “show,” and the like include video content, audio content, applications, animations, and the like. Video content includes television programs, movies, video recordings, and the like. Audio content includes music, audio recordings, podcasts, radio programs, spoken audio, and the like. Applications include code, scripts, widgets, games and the like. The terms “program,” “multimedia program,” and “show” include scheduled content (e.g., broadcast content and multicast content) and unscheduled content (e.g., on-demand content, pay-per-view content, downloaded content, streamed content, and stored content).

“Recording” means media data for playback. A recording is preferably a computer readable recording and may be, for example, a program, a music album, a television show, a movie, a game, a video, a broadcast of various types, an audio track, a video track, a song, a chapter, a CD recording, a DVD recording and/or a Blu-ray Disc recording, among other things.

“Server” means a software application that provides services to other computer programs (and their users), in the same or another computer. A server may also refer to the physical computer that has been set aside to run a specific server application. For example, when the software Apache HTTP Server is used as the web server for a company's website, the computer running Apache is also called the web server. Server applications can be divided among server computers over an extreme range, depending upon the workload.

“Signature” means an identifying means that uniquely identifies an item, such as, for example, a track, a song, an album, a CD, a DVD and/or Blu-ray Disc, among other items. Examples of a signature include without limitation the following in a computer-readable format: an audio fingerprint, a portion of an audio fingerprint, a signature derived from an audio fingerprint, an audio signature, a video signature, a disc signature, a CD signature, a DVD signature, a Blu-ray Disc signature, a media signature, a high definition media signature, a human fingerprint, a human footprint, an animal fingerprint, an animal footprint, a handwritten signature, an eye print, a biometric signature, a retinal signature, a retinal scan, a DNA signature, a DNA profile, a genetic signature and/or a genetic profile, among other signatures. A signature may be any computer-readable string of characters that comports with any coding standard in any language. Examples of a coding standard include without limitation alphabet, alphanumeric, decimal, hexadecimal, binary, American Standard Code for Information Interchange (ASCII), Unicode and/or Universal Character Set (UCS). Certain signatures may not initially be computer-readable. For example, latent human fingerprints may be printed on a door knob in the physical world. A signature that is initially not computer-readable may be converted into a computer-readable signature by using any appropriate conversion technique. For example, a conversion technique for converting a latent human fingerprint into a computer-readable signature may include a ridge characteristics analysis.

“Software” and “application” mean a computer program that is written in a programming language that may be used by one of ordinary skill in the art. The programming language chosen should be compatible with the computer by which the software application is to be executed and, in particular, with the operating system of that computer. Examples of suitable programming languages include without limitation Object Pascal, C, C++, and Java. Further, the functions of some embodiments, when described as a series of steps for a method, could be implemented as a series of software instructions for being operated by a processor, such that the embodiments could be implemented as software, hardware, or a combination thereof. Computer readable media are discussed in more detail in a separate section below.

“Song” means a musical composition. A song is typically recorded onto a track by a record label (e.g., recording company). A song may have many different versions, for example, a radio version and an extended version.

“System” means a device or multiple coupled devices. A device is defined above.

A “tag” means an item of metadata, such as an item of time-localized metadata.

“Tagging” means associating at least a portion of content with metadata, for instance, by storing the metadata together with, or separately from, the portion of content described by the metadata.

“Theme song” means any audio content that is a portion of a multimedia program, such as a television program, and that recurs across multiple occurrences, or episodes, of the multimedia program. A theme song may be a signature tune, song, and/or other audio content, and may include music, lyrics, and/or sound effects. A theme song may occur at any time during the multimedia program transmission, but typically plays during a title sequence and/or during the end credits.

“Time-localized metadata” means metadata that describes, or is applicable to, a portion of content, where the metadata includes a time span during which the metadata is applicable. The time span can be represented by a start time and end time, a start time and a duration, or any other suitable means of representing a time span.

“Track” means an audio/video data block. A track may be on a disc, such as, for example, a Blu-ray Disc, a CD or a DVD.

“User device” (e.g., “client”, “client device”, “user computer”) is a hardware system, a software operating system and/or one or more software application programs. A user device may refer to a single computer or to a network of interacting computers. A user device may be the client part of a client-server architecture. A user device typically relies on a server to perform some operations. Examples of a user device include without limitation a television (TV), a CD player, a DVD player, a Blu-ray Disc player, a personal media device, a portable media player, an iPod™, a Zoom Player, a laptop computer, a palmtop computer, a smart phone, a cell phone, a mobile phone, an MP3 player, a digital audio recorder, a digital video recorder (DVR), a set top box (STB), a network attached storage (NAS) device, a gaming device, an IBM-type personal computer (PC) having an operating system such as Microsoft Windows™, an Apple™ computer having an operating system such as MAC-OS, hardware having a JAVA-OS operating system, and a Sun Microsystems Workstation having a UNIX operating system.

“Web browser” means any software program which can display text, graphics, or both, from Web pages on Web sites. Examples of a Web browser include without limitation Mozilla Firefox™ and Microsoft Internet Explorer™.

“Web page” means any documents written in mark-up language including without limitation HTML (hypertext mark-up language) or VRML (virtual reality modeling language), dynamic HTML, XML (extensible mark-up language) or related computer languages thereof, as well as to any collection of such documents reachable through one specific Internet address or at one specific Web site, or any document obtainable through a particular URL (Uniform Resource Locator).

“Web server” refers to a computer or other electronic device which is capable of serving at least one Web page to a Web browser. An example of a Web server is a Yahoo™ Web server.

“Web site” means at least one Web page, and more commonly a plurality of Web pages, virtually coupled to form a coherent group.

### III. System

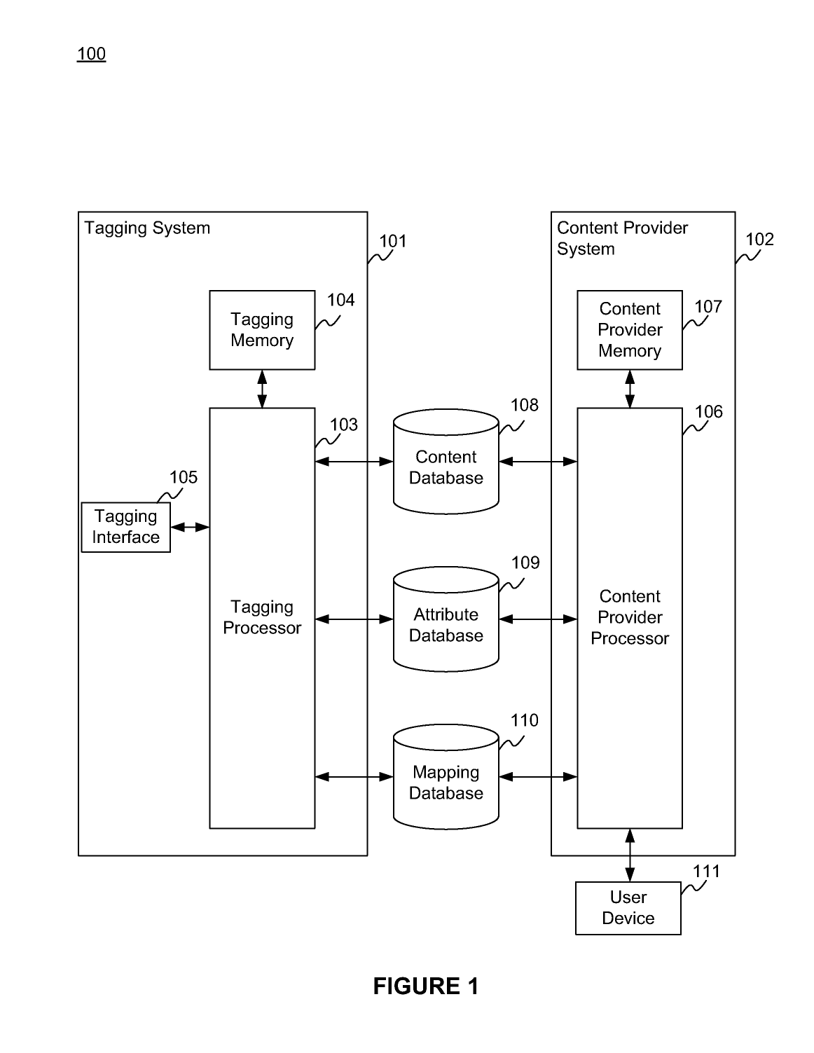

FIG. 1 is a diagram of a system 100 for tagging, communicating, and receiving data including time-localized metadata in which some embodiments are implemented. System 100 includes a tagging system 101, a content provider system 102, a user device 111, and one or more databases 108, 109, and 110 that store content, metadata, and/or mapping information, respectively. Content, such as audio content, image content, and/or video content, is stored in content database 108. Attribute information, such as an attribute or an attribute category, is stored in attribute database 109. Mapping information, which associates content with corresponding attribute information, is stored in mapping database 110. Tagging system 101 is used to tag content with time-localized metadata. “Tagging” may also be interchangeably referred to herein as “associating.” Content provider system 102 provides, to user device 111, content that has been tagged with time-localized metadata. User device 111 allows, among other things, playback or utilization of the content with time-localized metadata.

Tagging system 101 includes a tagging processor 103, which is communicatively coupled to a tagging memory 104 and a tagging interface 105, as well as to content database 108, attribute database 109, and mapping database 110. The tagging interface 105 provides a graphical user interface (GUI) that enables a user to cause the tagging processor 103 to execute program instructions stored in the tagging memory 104 to tag content stored in content database 108 with time-localized metadata.

As discussed in further detail below, tagging can be performed according to one of two exemplary tag modes—an “included-tag” (or “first”) mode and a “separate-tag” (or “second”) mode. In the included-tag mode, all time-localized metadata corresponding to a particular content file is stored within the content file itself. In the separate-tag mode, at least a portion of the time-localized metadata is stored separately from the content file itself.

In one embodiment for implementing the separate-tag mode, a tag identifier is stored within the content file. This stored tag identifier is used in conjunction with attribute information and mapping information stored in attribute database 109 and mapping database 110, respectively, to fully represent the time-localized metadata associated with the content file.

As explained in more detail below, tagging system 101, depending on whether it is implementing the included-tag mode or the separate-tag mode, utilizes content database 108, attribute database 109, and/or mapping database 110, to tag content with time-localized metadata.

Content provider system 102 provides, to user device 111, content that has been tagged with time-localized metadata. Referring still to FIG. 1, content provider system 102 includes a processor, content provider processor 106, which is communicatively coupled to a memory, content provider memory 107, as well as to content database 108, attribute database 109, and mapping database 110.

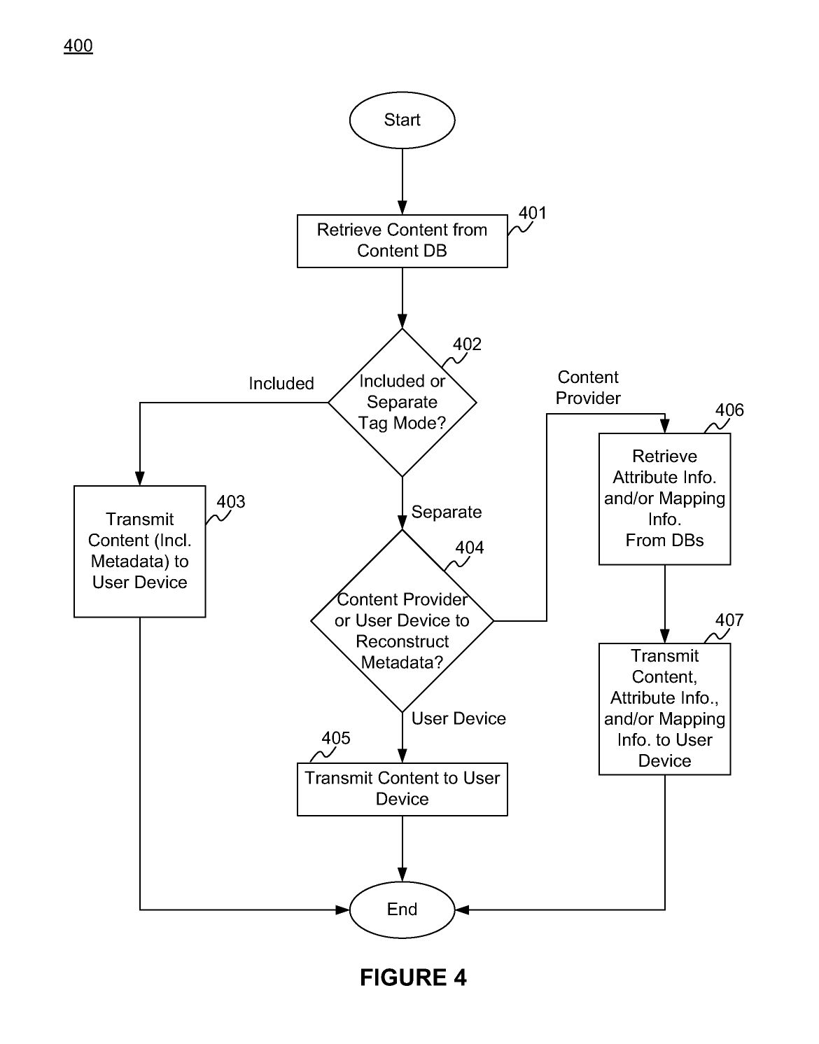

Content provider processor 106 executes program instructions stored in the content provider memory 107 that utilize content database 108, attribute database 109, and/or mapping database 110, to provide user device 111 with content that has been tagged with time-localized metadata. In one embodiment, content provider system 102 provides content to user device 111 by streaming the content as data packets over a network, such as the Internet. As described in more detail below in connection with FIG. 4, the provision of content tagged with time-localized metadata depends on whether the included-tag mode or the separate-tag mode is implemented.

In other embodiments, one or more of databases 108, 109, and 110 are included within one or more of tagging system 101, content provider system 102, and/or user device 111.

In yet another embodiment, one of databases 108, 109, and 110 is omitted. For example, where the included-tag mode is used, mapping database 110 can be omitted from system 100. In another embodiment, for example where tagging system 101, and/or content database 108 are included within user device 111, content provider system 102 can be omitted from system 100.

Additionally, various portions of system 100—such as those providing tagging functionality, content provider functionality, user device 111, etc.—can be operated as standalone systems, e.g., by operating without the assistance of other portions of system 100. In one embodiment, content database 108, attribute database 109, and/or mapping database 110 are included within tagging system 101, content provider system 102, and/or user device 111. Alternatively, content database 108, attribute database 109, and/or mapping database 110 may be included within a portable data storage device such as a flash drive.

### IV. Tagging

### A. Format of Time-Localized Metadata

As explained above, time-localized metadata means metadata that describes, or is applicable to, a portion of content, where the metadata includes a time span during which the metadata is applicable. The time span can be represented by a start time and end time, a start time and a duration, or any other suitable means of representing a time span. For example, time-localized metadata can be data which describes a portion of multimedia content (e.g., a portion of a particular movie) by including an attribute, as well as a start time and end time for which the attribute is applicable. Time-localized metadata can optionally includes a tag identifier that uniquely identifies each tag of time-localized metadata. In this case, each tag includes a tag identifier, an attribute, a start time, and an end time. A portion of content may include multiple tag identifiers and these tag identifiers may apply to overlapping time regions of the portion of content. Table 1 below illustrates a set of time-localized metadata for a portion of content that includes N time-localized tags (“tag_{N}”).

TABLE 1

| Tag Identifier | Attribute | Start Time | End Time |
|---|---|---|---|
| tag₁ | attribute₁ | start_time₁ | end_time₁ |
| tag₂ | attribute₂ | start_time₂ | end_time₂ |
| . . . | . . . | . . . | . . . |
| tag_{N} | attribute_{N} | start_time_{N} | end_time_{N} |

Each start time (“start_time_{N}”) and end time (“end_time_{N}”) may be represented by any form of data that indicates a relative time position such as, for example, a number indicating a time value relative to the beginning time of a portion of content. Alternatively, the start time and end time may be represented by an absolute address pointer or a relative address pointer (e.g., address offset). The attribute (“attribute_{N}”) is selected from a list of attributes, or other attribute information, stored within attribute database 109.

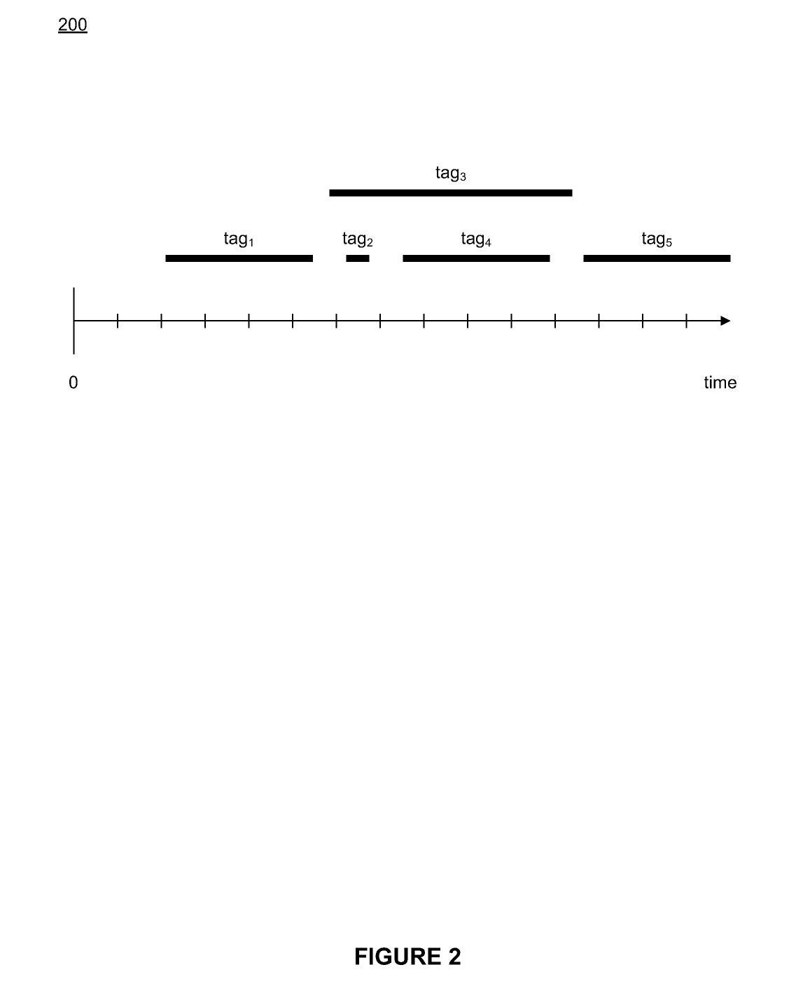

FIG. 2 is a timeline 200 representing a portion of content that has been tagged with time-localized metadata. Timeline 200 represents an entire time span of a portion of content (e.g., a song) from start to finish, and is shown as a horizontal line where time increases from left to right. The portion of content begins at time “0” and ends at time “t”. Above the timeline are tags indicated by horizontal line segments labeled with the following tag identifiers: tag₁, tag₂, tag₃, tag₄, and tag₅. Each of the tags represents an item of time-localized metadata such as an attribute that is applicable during the portion of the content indicated by the time span of the tag. As shown in FIG. 2, any number of attributes in the form of tags can be applicable at any given time for a given portion of content.

### B. Tag Modes

As discussed above, example tag modes include an included-tag mode and a separate-tag mode. For the included-tag mode, if the content is stored and/or transmitted as a single file then time-localized metadata (e.g., tag identifier (tag_{N}), attribute (attribute_{N}), start time (start_time_{N}), and end time (end_time_{N}), as indicated above in Table 1) are stored within the file, for example, as part of a file header. If the content is stored and/or transmitted, e.g., via a network as a stream of data packets, then time-localized metadata is stored within the data packets. For example, a tag identifier (e.g., an alphanumerical string), an attribute (or other attribute information), and a start marker are stored within a packet corresponding to the earliest (in time) portion of the content stream for which the attribute is applicable. The tag identifier, attribute, and a corresponding end marker are also stored within a packet corresponding to the latest (in time) portion of the content stream for which the attribute is applicable. Alternatively, in an embodiment where the content is transmitted as a stream of data packets via a network, the start marker and end marker are omitted because the start and end times are indicated by the packets that include the tag identifiers.

For the separate-tag mode, if the content is stored and/or transmitted as a single file then a tag identifier (such as those indicated above in the Tag Identifier column of Table 1) is stored within the file, for example, as part of its file header. If the content is stored and/or transmitted, e.g., via a network, as a stream of data packets then the tag identifier is stored within one or more of the data packets. The remainder of the time-localized metadata (such as the attributes, start times, and end times indicated above in the three rightmost columns of Table 1) are represented by attribute information stored within attribute database 109 and a mapping table stored within mapping database 110. In particular, the mapping table, which is generated by tagging processor 103, includes, for each tag identifier, an entry that maps or links the tag identifier to the remainder of the attribute information—the corresponding attribute, start time, and end time.

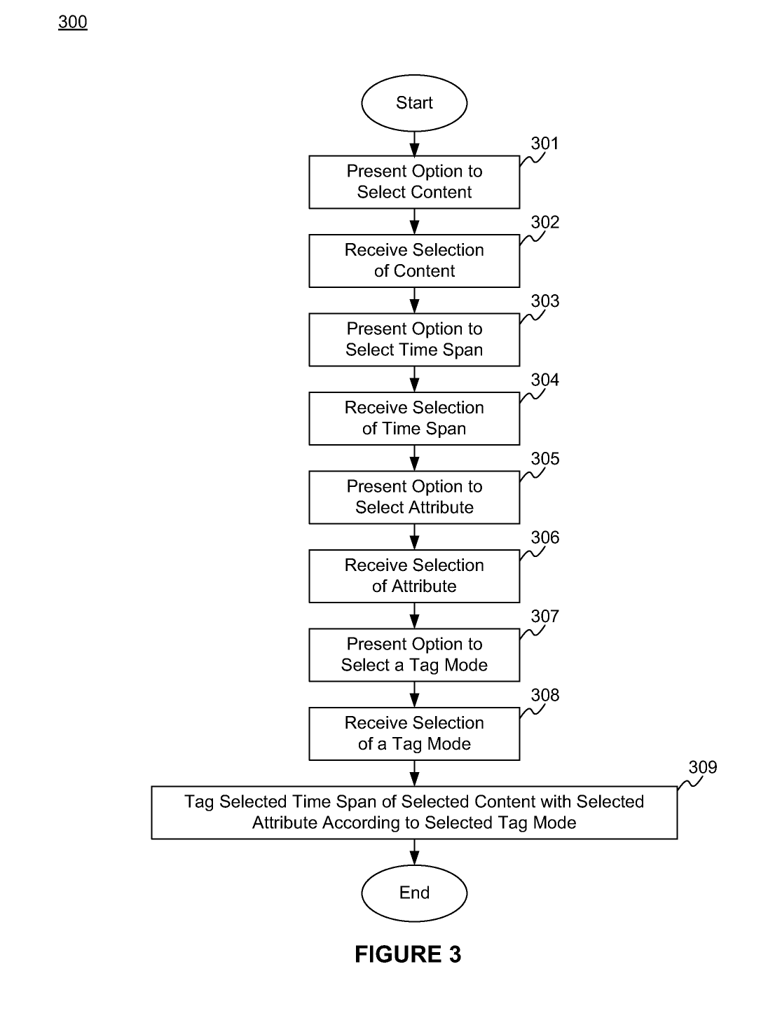

FIG. 3 is a flowchart diagram showing an exemplary procedure 300 for tagging content with time-localized metadata. It should be understood that procedure 300 need not be performed in the exact order presented in FIG. 3. For example, block 305 may be performed before block 303. At block 301, tagging processor 103 causes tagging interface 105 to present via the GUI an option to select an item of content stored in content database 108 to be tagged with time-localized metadata. For example, tagging processor 103 may cause tagging interface 105 to present, via the GUI, a dialog box for inputting the text of a song name. Tagging processor 103 then executes a search, such as a fuzzy search, of content database 108 based on the text inputted into the dialog box to identify an item of content corresponding to the song. Alternatively, tagging processor 103 causes tagging interface 105 to enable selection of an item of content, such as a song, via a graphical browser that includes a list of songs stored in content database 108. In another embodiment, tagging processor 103 causes tagging interface 105 to enable an item of content to be selected while the content is being played back.

Once a portion of content is identified, tagging processor 103 causes tagging interface 105 to present a GUI element permitting the user to select and confirm the song to be tagged with time-localized metadata. In another embodiment, a GUI element is not presented via a GUI. Instead, a processor can automatically select and confirm a song to be tagged with time-localized metadata based on a threshold or statistical probability that a text query matches content or other data stored in content database 108. Alternatively, tagging processor 103 could confirm a song to be tagged with time-localized metadata by using an audio fingerprint. In this example embodiment, tagging processor 103 generates an audio fingerprint based on the portion of content selected at block 301. Tagging processor 103 then compares the generated audio fingerprint to a collection of audio fingerprints, which are stored in a database (not shown), and which are linked to corresponding songs. Tagging processor 103 confirms the song to be tagged with time-localized metadata by matching the generated audio fingerprint to an audio fingerprint in the collection of audio fingerprints. At block 302, tagging processor 103 receives from tagging interface 105 a selection of an item of content stored in content database 108.

At block 303, tagging processor 103 causes tagging interface 105 to present, via the GUI, an option to select a time span or portion of the item of content selected at block 302 to be tagged with time-localized metadata. For example, tagging processor 103 may cause tagging interface 105 to present, via the GUI, a timeline corresponding to the item of content (e.g., a song) selected at block 302. Tagging interface 105 may then accept a user inputted start time and end time of the portion of content to be tagged with time-localized metadata.

In one embodiment, tagging interface 105 presents, or plays back, the content to a user to enable selection of a start time and an end time while the content is being played back. In particular, tagging processor 103 causes tagging interface 105 to present a GUI element permitting a user to select a portion of content while the content is being played back. For instance, while a particular song is being played back on a user device, a portion of the song may be selected, via a GUI, to be tagged with time-localized metadata as discussed in further detail below.

Tagging interface 105 transmits the inputted start time and end time to tagging processor 103. As discussed above, in some embodiments, the portion of content is represented by a start time and a duration instead of a start time and end time. At block 304, tagging processor 103 receives from tagging interface 105 a selection of a time span or portion of the selected item of content to be tagged with time-localized metadata.

At block 305, tagging processor 103 causes tagging interface 105 to present, via the GUI, an option to select an attribute to be tagged onto the selected time span of the selected portion of content. For example, tagging processor 103 may cause tagging interface 105 to present, via the GUI, a dropdown list of possible attributes to be selected from attribute database 109 for association with the portion of content defined at blocks 302 and 304.

In another embodiment, tagging processor 103 causes tagging interface 105 to present, via the GUI, a browser displaying a categorized list of selectable attributes stored in attribute database 109. Alternatively, tagging processor 103 may cause tagging interface 105 to present, via the GUI, a search box in which a user may input a search string to search for an attribute stored in attribute database 109. In still another aspect, tagging processor 103 causes tagging interface 105 to present, via the GUI, a GUI element enabling a user to create a custom attribute to be tagged onto the selected portion of content. The custom attribute may be created from scratch or based on any one or more of the attributes stored in attribute database 109.

Once the attribute has been created or selected, tagging interface 105 transmits the selected attribute to tagging processor 103. At block 306, tagging processor 103 receives from tagging interface 105 the selection of the attribute to be tagged onto the selected time span of the selected portion of content.

At block 307, tagging processor 103 causes tagging interface 105 to present, via the GUI, an option to select a tag mode from either an included-tag mode or a separate-tag mode, each of which is discussed in further detail above. For example, tagging processor 103 causes tagging interface 105 to present, via the GUI, a radio button corresponding to either included or separate-tag mode.

In one embodiment, instead of a user selecting a tag mode, a tag mode is predetermined by a previous configuration of tagging system 101. At block 308, tagging processor 103 receives from tagging interface 105 the selection of the tag mode from either the included-tag mode or the separate-tag mode.

At block 309, tagging processor 103 tags the selected time span or portion of the selected item of content with the selected attribute according to the selected tag mode.

### C. Collaborative Tagging

In one embodiment, tagging system 101 is incorporated within user device 111. In this way, a user of the content is able to tag content with time-localized metadata according to his or her personal opinions of the content. In another embodiment, tagging system 101 is included within a system of a content source, such as an originator, provider, publisher, distributor and/or broadcaster of content. In this way, content may be tagged with time-localized metadata according to the opinions or rules of a content producer or other third party. The tag data or content including tag data, which has been generated by such third party, can then be transmitted to multiple user devices for multiple users to experience. Alternatively, tagging system 101 may be incorporated within user device 111 as well as within a system of a content source, enabling both users and content sources to collaboratively tag content with time-localized metadata. A combination of both third party and end-user tagging data can thus be associated to content.

In one embodiment, collaboratively-entered time-localized metadata is filtered to identify time-localized metadata on which a predetermined number of collaborating users agree. The identified time-localized metadata is then accepted as valid and stored in a database. The validity of the time-localized metadata can be increased by requiring a high predetermined number of users before accepting the time-localized metadata and storing it in the database.

In a related embodiment, collaboratively-entered time-localized metadata is transmitted to and stored on user device 111 if a relevance value, which is computed by inputting an item of time-localized metadata into a relevance algorithm, is greater than or equal to a predetermined relevance threshold, which is computed based on predetermined preferences of a user of user device 111. The relevance value for a particular item of time-localized metadata and a particular user may be equal to, for example, an aggregate amount of time-localized metadata items inputted by that user into tagging system 101 in connection with that particular item of time-localized metadata. For instance, if a user of user device 111 has a preference for rock music, as determined based on a high amount of rock music-related time-localized metadata items inputted into tagging system 101, then collaboratively-entered time-localized metadata relating to rock music is transmitted to and stored on user device 111.

### D. Automated Tagging

In another embodiment, automated means, e.g., audio fingerprinting, are used to tag content. For example, a collection of audio fingerprints is stored in a database, with each audio fingerprint being linked to a corresponding song and corresponding time-localized metadata (e.g., tag identifier(s), start time(s), end time(s)). Songs stored on user device 111 are automatically tagged with the corresponding time-localized metadata stored in the database. Specifically, for a particular song stored on user device 111, an audio fingerprint is generated. The generated audio fingerprint is matched to a corresponding audio fingerprint stored in the database. The time-localized metadata corresponding to the matched audio fingerprint is retrieved from the database and can be stored on user device 111 by using either the included-tag mode or separate-tag mode, as discussed above. This procedure can be automatically executed for multiple songs stored on user device 111.

As another example, songs that appear as background music of a movie can be identified by comparing and matching their audio fingerprints to those stored in the database. The movie can then be automatically tagged with time-localized metadata indicating the occurrences of particular background songs.

In another embodiment, appearances of a particular actor in a movie are identified by applying a facial recognition algorithm to the video content of the movie and comparing the results to a collection of actor images stored in a database. The movie is then automatically tagged with time-localized metadata indicating scenes featuring the actor.

Alternatively, or in addition, video fingerprinting can be used to tag content. A collection of video fingerprints is stored in a database, with each audio fingerprint being linked to a corresponding movie (or other audio-visual content) and corresponding time-localized metadata (e.g., tag identifier(s), start time(s), end time(s)). Movies stored on user device 111 are automatically tagged with the corresponding time-localized metadata stored in the database. Specifically, for a particular movie stored on user device 111, a video fingerprint is generated. The generated video fingerprint is matched to a corresponding video fingerprint stored in the database. The time-localized metadata corresponding to the matched video fingerprint is retrieved from the database and can be stored on user device 111 by using either the included-tag mode or separate-tag mode, as discussed above. This procedure can be automatically executed for multiple movies stored on user device 111.

In a further embodiment, album identifiers (e.g., tables of contents, sometimes also referred to as TOCs) are used to tag content. A collection of TOCs is stored in a database, with each TOC being linked to corresponding tracks and corresponding time-localized metadata (e.g., tag identifier(s), start time(s), end time(s)). Albums stored on user device 111 are automatically tagged with the corresponding time-localized metadata stored in the database. Specifically, for a particular album stored on user device 111, the TOC is matched to a corresponding TOC stored in the database. The time-localized metadata corresponding to the album (or, more specifically, the track(s)) of the matched TOC is retrieved from the database and can be stored on user device 111 by using either the included-tag mode or separate-tag mode, as discussed above. This procedure can be automatically executed for multiple albums stored on user device 111.

### V. Transmitting Time-Localized Metadata

FIG. 4 is a flowchart diagram showing an exemplary procedure 400 for transmitting, to user device 111, content that has been tagged with time-localized metadata. At block 401, content provider processor 106 retrieves content from content database 108. For example, content provider 106 retrieves a movie or song that has been selected from content database 108 for playback via user device 111.

At block 402, content provider processor 106 determines whether the retrieved content has been tagged according to the included-tag mode or the separate-tag mode. Content provider processor 106 makes this determination by, for example, reading a corresponding tag mode identifier or flag in the header of the content file. Alternatively, or in addition, content provider processor 106 makes this determination by reading the content file to determine whether it includes complete time-localized metadata (e.g., tag identifier, attribute, start time, end time, duration) or only a tag identifier. If the content file includes complete time-localized metadata then the content has been tagged according to the included-tag mode; if the content file includes only a tag identifier then the content has been tagged according to the separate-tag mode.

If at block 402, content provider processor 106 determines that the retrieved content has been tagged according to the included-tag mode, then at block 403 content provider processor 106 transmits, to user device 111 via a communication channel such as a network, the content retrieved at block 401.

As discussed above, for separate-tag mode, to represent time-localized metadata, mapping information stored in mapping database 110 is used to link, or combine, tag identifiers stored in a content file with attribute information stored in attribute database 109. This procedure may also be referred to herein as “reconstruction of metadata” or “metadata reconstruction.” Metadata is reconstructed by either content provider processor 106 or by user device 111. In the event metadata is reconstructed by user device 111, user device 111 retrieves metadata and/or mapping information from metadata and/or mapping databases, respectively, which may be either local or remote with respect to user device 111.

If at block 402, content provider processor 106 determines that the retrieved content has been tagged according to the separate-tag mode, then at block 404 content provider processor 106 determines whether metadata is to be reconstructed by content provider processor 106 or by user device 111. Content provider processor 106 makes this determination by, for example, reading a corresponding reconstruction mode identifier or flag in the header of the content file.

If at block 404, content provider processor 106 determines that metadata is to be reconstructed by user device 111, then at block 405 content provider processor 106 transmits, to user device 111 via a communication channel such as a network, the content retrieved at block 401.

If at block 404, content provider processor 106 determines that metadata is to be reconstructed by content provider processor 106, then at block 406 content provider processor 106 retrieves attribute information and/or mapping information from attribute database 109 and mapping database 110, respectively.

At block 407, content provider processor 106 transmits, to user device 111 via a communication channel such as a network, the content, the attribute information, and/or the mapping information retrieved at blocks 401 and 406, respectively.

### VI. Receiving & Utilizing Time-Localized Metadata

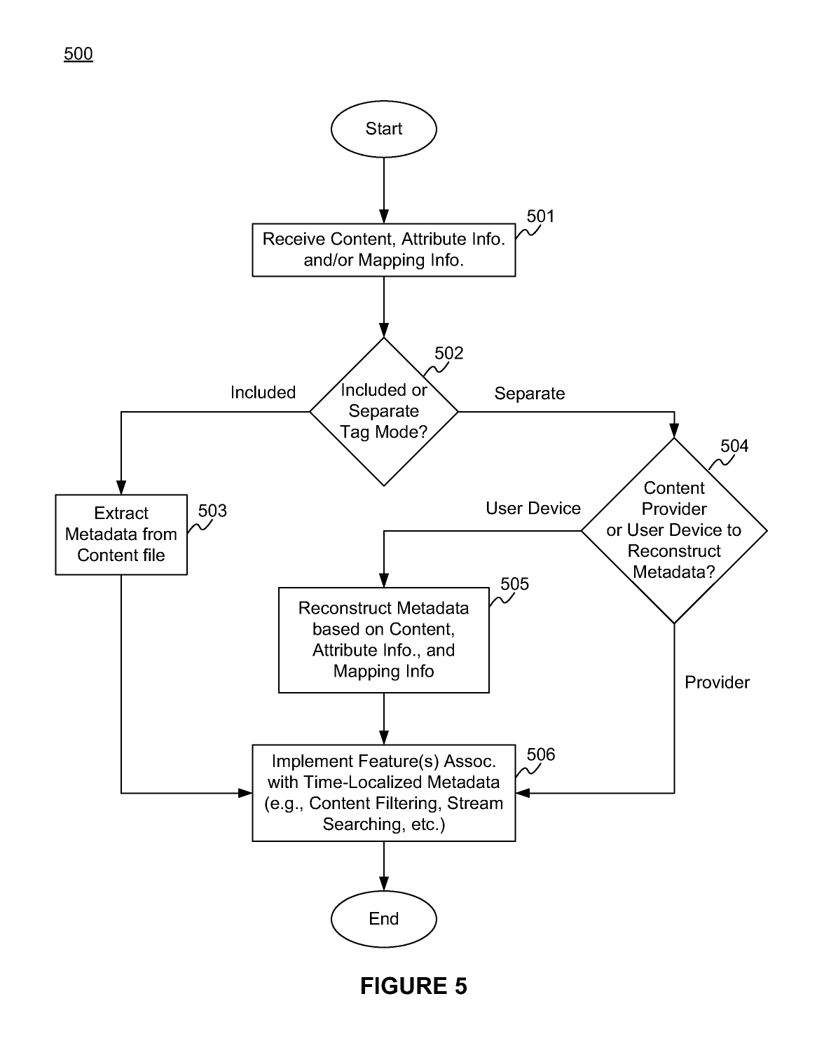

FIG. 5 is a flowchart diagram showing an exemplary procedure 500 for receiving and utilizing content that has been tagged with time-localized metadata. At block 501, user device 111 receives, from content provider processor 106, content, attribute information, and/or mapping information. As discussed above, the content may have been tagged with time-localized metadata according either the included-tag mode or the separate-tag mode.

At block 502, user device 111 determines whether the received content was tagged according to the included-tag mode or the separate-tag mode. User device 111 makes this determination by, for example, reading a corresponding tag mode identifier or flag in the header of the corresponding content file. Alternatively, or in addition, user device 111 makes this determination by reading the content file to determine whether it includes complete time-localized metadata (e.g., tag identifier, attribute, start time, and end time) or only a tag identifier. If the content file includes complete time-localized metadata then the content has been tagged according to the included-tag mode; if the content file includes only a tag identifier then the content has been tagged according to the separate-tag mode.

If at block 502, user device 111 determines that the received content was tagged according to the included-tag mode then at block 503, user device 111 extracts time-localized metadata from the file (or from the data packet if the content is sent via streaming). At block 506, user device 111 implements one or more features associated with the time-localized metadata, as discussed below in more detail.

If at block 502, user device 111 determines that the received content was tagged according to the separate-tag mode then at block 504, user device 111 determines whether the time-localized metadata has been reconstructed by content provider processor 106 or is to be reconstructed by user device 111. User device 111 makes this determination by, for example, reading a corresponding reconstruction mode identifier or flag in the header of the corresponding content file.

If at block 504, user device 111 determines that time-localized metadata has been reconstructed by content provider processor 106, then at block 506 user device 111 implements one or more features associated with the time-localized metadata, as discussed below in more detail.

If at block 504, user device 111 determines that time-localized metadata is to be reconstructed by user device 111, then at block 505 user device 111 reconstructs time-localized metadata by using mapping information stored in mapping database 110 to combine tag identifiers stored in the content file with attribute information (e.g., attributes) stored in attribute database 109. As discussed above, the mapping information and/or attribute information may be stored in mapping databases 109 and 110, respectively. Alternatively, or in addition, the mapping information and/or attribute information may be stored in one or more database(s) stored locally within user device 111.

At block 506, implements one or more features associated with the time-localized metadata, as discussed below in more detail.

### VII. Features Associated with Time-Localized Metadata

Time-localized metadata can be used to implement any number of associated features. Example features associated with time-localized metadata include content filtering, stream searching, advertisement placement, providing content recommendations, and stream playlisting.

### A. Content Filtering

To implement content filtering, content, for instance content corresponding to a motion picture or film, is tagged with time-localized metadata associating one or more attributes with corresponding portions of the content. For example, violent scenes are tagged with a “violence” attribute; action scenes are tagged with an “action” attribute; time instances during which a given actor appears in the film are tagged with an “[insert actor identifier]” attribute; time instances during which music is playing in the audio portion of the film are tagged with a “music” attribute, etc.

User device 111 or content provider processor 106 then filters the content based on the tags. For example, all violent scenes can be removed by removing the portions of content that have been tagged with a “violence” attribute; action scenes may be removed by removing the portions of content that have been tagged with an “action” attribute; scenes featuring a given actor may be removed by removing the portions of content that have been tagged with an “[insert actor identifier]” attribute; scenes featuring a song may be removed by removing the portions of the film that have been tagged with a “music” attribute, etc.

### B. Stream Searching

To implement stream searching, as with content filtering, content, for instance content corresponding to a motion picture or film, is tagged with time-localized metadata associating one or more attributes with corresponding portions of the content. A user searches, via a user interface of user device 111, for portions of content that match a given search query. For example, user device 111 may identify violent scenes by identifying the portions of content that have been tagged with a “violence” attribute; user device 111 may identify action scenes by identifying the portions of content that have been tagged with an “action” attribute; user device may identify scenes featuring a given actor may by identifying the portions of content that have been tagged with an “[insert actor identifier]” attribute; user device 111 may identify scenes featuring music by identifying the portions of the film that have been tagged with a “music” attribute; user device 111 may identify an interview of a certain guest on a show by identifying a portion of content that has been tagged with an “interviewee” attribute; user device 111 may identify a particular topic of discussion on a show by identifying a portion of content that has been tagged with a “topic” attribute, and/or the like, etc. Once identified, portions of content that match the search query can be selected for playback.

In one embodiment, the search query is executed via a user interface, such as a keyboard or an interface capable of performing speech recognition.

### C. Advertisement Placement

To implement advertisement placement, content, such as content corresponding to a television broadcast, is tagged with time-localized “commercial break” attributes. For instance, the beginning of a commercial break may be indicated by a commercial break marker having an identical start time and end time.

In addition, a table of advertisements is stored in a database, where each advertisement is tagged with metadata associating it with one or more attributes. Content provider processor 106 implements a similarity function to compute a similarity between attributes of a television program near a particular commercial break marker and attributes of the advertisements stored in the database. For example, the content provider processor 106 may compute a similarity based on a number of attributes (occurring near the commercial break marker) that are common to a given program and an advertisement. In one embodiment, in computing a similarity, the content provider processor 106 assigns, to each tag, a weighting factor having a value that decreases in proportion to the time difference between the tag and the commercial break marker. Alternatively, or in addition, in computing the similarity, the content provider processor 106 assigns a higher weighting factor to each tag that is located within a predetermined time span from the commercial break marker.

The effectiveness of the advertisements is optimized by identifying, and inserting into the broadcast at the corresponding commercial break time, advertisement(s) having the highest computed similarity.

In another embodiment, the similarity function is used to avoid placing an advertisement in a time slot that would have a negative advertising effect. For example, the similarity function can be used to compare alcohol-related attributes, avoiding the placement of an alcohol advertisement after a television program scene featuring a character killed by a drunk driver.

### D. Content Recommendation

To implement content recommendation, the content provider processor 106 implements a similarity function (e.g., as discussed above) to compute a similarity between attributes of a predetermined portion of content and other content or products. The content provider processor 106 identifies and provides a recommendation for other content, products, etc., for which the content provider processor 106 has computed a high similarity (based on, for example, a predetermined similarity threshold) to the tags for the predetermined portion of content.

### E. Stream Playlisting

To implement stream playlisting, the content provider processor 106 or user device 111 implements an algorithm to select a subsequent portion of content to be played based on a computed similarity between tags occurring at the end of a currently playing portion of content and those occurring at the beginning of the subsequent portion of content. The content provider processor 106 or user device 111 thus generates a playlist of content having seamless transitions based on tag similarity.

In one embodiment, the content provider processor 106 or user device 111, in implementing the algorithm, assigns, to matching tags corresponding to two portions of content, respectively, a weighting factor that decreases in value in proportion to the time difference between the two tags. For example, a tag that appears near the end of a first portion of content and that also appears near the beginning of a second portion of content would result in a higher similarity than if the two tags were farther separated in time. In this way, transitions are made more seamless by deeming attributes that occur most near the transitions themselves more relevant in the similarity computation.

### VIII. Computer Readable Medium Implementation

The example embodiments described above such as, for example, the systems and procedures depicted in or discussed in connection with FIGS. 1, 2, 3, 4, and 5, or any part or function thereof, may be implemented by using hardware, software or a combination of the two. The implementation may be in one or more computers or other processing systems. While manipulations performed by these example embodiments may have been referred to in terms commonly associated with mental operations performed by a human operator, no human operator is needed to perform any of the operations described herein. In other words, the operations may be completely implemented with machine operations. Useful machines for performing the operation of the example embodiments presented herein include general purpose digital computers or similar devices.

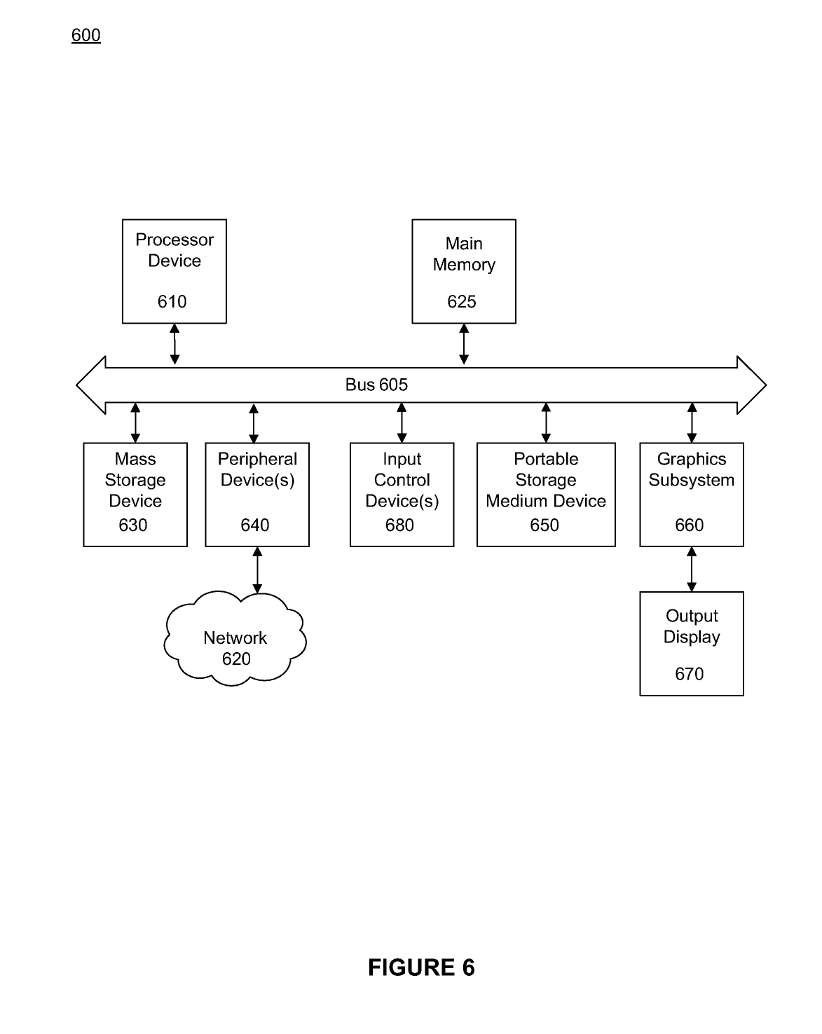

FIG. 6 is a block diagram of a general and/or special purpose computer 600, in accordance with some of the example embodiments of the invention. The computer 600 may be, for example, a user device, a user computer, a client computer and/or a server computer, among other things.

The computer 600 may include without limitation a processor device 610, a main memory 625, and an interconnect bus 605. The processor device 610 may include without limitation a single microprocessor, or may include a plurality of microprocessors for configuring the computer 600 as a multi-processor system. The main memory 625 stores, among other things, instructions and/or data for execution by the processor device 610. The main memory 625 may include banks of dynamic random access memory (DRAM), as well as cache memory.

The computer 600 may further include a mass storage device 630, peripheral device(s) 640, portable storage medium device(s) 650, input control device(s) 680, a graphics subsystem 660, and/or an output display 670. For explanatory purposes, all components in the computer 600 are shown in FIG. 6 as being coupled via the bus 605. However, the computer 600 is not so limited. Devices of the computer 600 may be coupled via one or more data transport means. For example, the processor device 610 and/or the main memory 625 may be coupled via a local microprocessor bus. The mass storage device 630, peripheral device(s) 640, portable storage medium device(s) 650, and/or graphics subsystem 660 may be coupled via one or more input/output (I/O) buses. The mass storage device 630 may be a nonvolatile storage device for storing data and/or instructions for use by the processor device 610. The mass storage device 630 may be implemented, for example, with a magnetic disk drive or an optical disk drive. In a software embodiment, the mass storage device 630 is configured for loading contents of the mass storage device 630 into the main memory 625.

The portable storage medium device 650 operates in conjunction with a nonvolatile portable storage medium, such as, for example, a compact disc read only memory (CD-ROM), to input and output data and code to and from the computer 600. In some embodiments, the software for storing an internal identifier in metadata may be stored on a portable storage medium, and may be inputted into the computer 600 via the portable storage medium device 650. The peripheral device(s) 640 may include any type of computer support device, such as, for example, an input/output (I/O) interface configured to add additional functionality to the computer 600. For example, the peripheral device(s) 640 may include a network interface card for interfacing the computer 600 with a network 620.

The input control device(s) 680 provide a portion of the user interface for a user of the computer 600. The input control device(s) 680 may include a keypad and/or a cursor control device. The keypad may be configured for inputting alphanumeric characters and/or other key information. The cursor control device may include, for example, a mouse, a trackball, a stylus, and/or cursor direction keys. In order to display textual and graphical information, the computer 600 may include the graphics subsystem 660 and the output display 670. The output display 670 may include a cathode ray tube (CRT) display and/or a liquid crystal display (LCD). The graphics subsystem 660 receives textual and graphical information, and processes the information for output to the output display 670.

Each component of the computer 600 may represent a broad category of a computer component of a general and/or special purpose computer. Components of the computer 600 are not limited to the specific implementations provided here.

Portions of the example embodiments of the invention may be conveniently implemented by using a conventional general purpose computer, a specialized digital computer and/or a microprocessor programmed according to the teachings of the present disclosure, as is apparent to those skilled in the computer art. Appropriate software coding may readily be prepared by skilled programmers based on the teachings of the present disclosure.

Some embodiments may also be implemented by the preparation of application-specific integrated circuits, field programmable gate arrays, or by interconnecting an appropriate network of conventional component circuits.

Some embodiments include a computer program product. The computer program product may be a storage medium or media having instructions stored thereon or therein which can be used to control, or cause, a computer to perform any of the procedures of the example embodiments of the invention. The storage medium may include without limitation a floppy disk, a mini disk, an optical disc, a Blu-ray Disc, a DVD, a CD-ROM, a micro-drive, a magneto-optical disk, a ROM, a RAM, an EPROM, an EEPROM, a DRAM, a VRAM, a flash memory, a flash card, a magnetic card, an optical card, nanosystems, a molecular memory integrated circuit, a RAID, remote data storage/archive/warehousing, and/or any other type of device suitable for storing instructions and/or data.

Stored on any one of the computer readable medium or media, some implementations include software for controlling both the hardware of the general and/or special computer or microprocessor, and for enabling the computer or microprocessor to interact with a human user or other mechanism utilizing the results of the example embodiments of the invention. Such software may include without limitation device drivers, operating systems, and user applications. Ultimately, such computer readable media further includes software for performing example aspects of the invention, as described above.

Included in the programming and/or software of the general and/or special purpose computer or microprocessor are software modules for implementing the procedures described above.

While various example embodiments of the invention have been described above, it should be understood that they have been presented by way of example, and not limitation. It is apparent to persons skilled in the relevant art(s) that various changes in form and detail can be made therein. Thus, the invention should not be limited by any of the above described example embodiments, but should be defined only in accordance with the following claims and their equivalents.

In addition, it should be understood that the figures are presented for example purposes only. The architecture of the example embodiments presented herein is sufficiently flexible and configurable, such that it may be utilized and navigated in ways other than that shown in the accompanying figures.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

1. A method for communicating time-localized metadata, the method comprising steps of:
retrieving, from a first database, a portion of content associated with time-localized metadata;
retrieving, from a second database, the time-localized metadata and a tag mode identifier;
determining, based on at least one of the tag mode identifier and the time-localized metadata, a tag mode associated with the portion of content; and
transmitting, to a user device via a communication channel, at least one of the portion of content and the time-localized metadata, based at least in part on the tag mode.

2. The method of claim 1, further comprising steps of:
retrieving, from a third database, a reconstruction mode identifier;
determining, based on at least one of the time-localized metadata and the reconstruction mode identifier, a reconstruction mode associated with the portion of content; and
transmitting, to the user device via the communication channel, at least one of the portion of content, the time-localized metadata, attribute information and mapping information, based at least in part on the reconstruction mode.

3. The method of claim 2, wherein the reconstruction mode is a first reconstruction mode, in which the time-localized metadata is reconstructed by the user device, or a second reconstruction mode, in which the time-localized metadata is reconstructed by a content provider system.

4. The method of claim 1, further comprising a step of:
retrieving, from an attribute database, attribute information;
retrieving, from a mapping database, mapping information; and
transmitting, to the user device via the communication channel, at least one of the attribute information and mapping information.

5. The method of claim 4, wherein the mapping information associates the portion of content with at least a portion of the attribute information.

6. The method of claim 1, wherein the tag mode is a first tag mode, in which time-localized metadata corresponding to the portion of content is stored within the portion of content, or a second tag mode, in which at least a portion of the time-localized metadata is stored separately from the portion of content.

7. The method of claim 1, wherein the time-localized metadata includes at least one of a tag identifier, an attribute, a start time, and an end time.

8. The method of claim 1, wherein the first database and the second database are the same database.

9. A system for communicating time-localized metadata, the system comprising at least one processor configured to:
retrieve, from a first database, a portion of content associated with time-localized metadata;
retrieve, from a second database, the time-localized metadata and a tag mode identifier;
determine, based on at least one of the tag mode identifier and the time-localized metadata, a tag mode associated with the portion of content; and
transmit, to a user device via a communication channel, at least one of the portion of content and the time-localized metadata, based at least in part on the tag mode.

10. The system of claim 9, wherein the at least one processor is further configured to:
retrieve, from a third database, a reconstruction mode identifier;
determine, based on at least one of the time-localized metadata and the reconstruction mode identifier, a reconstruction mode associated with the portion of content; and
transmit, to the user device via the communication channel, at least one of the portion of content, the time-localized metadata, attribute information and mapping information, based at least in part on the reconstruction mode.

11. The system of claim 10, wherein the reconstruction mode is a first reconstruction mode, in which the time-localized metadata is reconstructed by the user device, or a second reconstruction mode, in which the time-localized metadata is reconstructed by a content provider system.

12. The system of claim 9, wherein the at least one processor is further configured to:
retrieve, from an attribute database, attribute information;
retrieve, from a mapping database, mapping information; and
transmit, to the user device via the communication channel, at least one of the attribute information and mapping information.

13. The system of claim 12, wherein the mapping information associates the portion of content with at least a portion of the attribute information.

14. The system of claim 9, wherein the tag mode is a first tag mode, in which time-localized metadata corresponding to the portion of content is stored within the portion of content, or a second tag mode, in which at least a portion of the time-localized metadata is stored separately from the portion of content.

15. The system of claim 9, wherein the time-localized metadata includes at least one of a tag identifier, an attribute, a start time, and an end time.

16. The system of claim 9, wherein the first database and the second database are the same database.

17. A computer-readable medium having stored thereon sequences of instructions, the sequences of instructions including instructions, which, when executed by a processor, cause the processor to perform:
retrieving, from a first database, a portion of content associated with time-localized metadata;
retrieving, from a second database, the time-localized metadata and a tag mode identifier;
determining, based on at least one of the tag mode identifier and the time-localized metadata, a tag mode associated with the portion of content; and
transmitting, to a user device via a communication channel, at least one of the portion of content and the time-localized metadata, based at least in part on the tag mode.

18. The computer-readable medium of claim 17, wherein the sequences of instructions further include instructions, which, when executed by the processor, cause the processor to perform:
retrieving, from a third database, a reconstruction mode identifier;
determining, based on at least one of the time-localized metadata and the reconstruction mode identifier, a reconstruction mode associated with the portion of content; and
transmitting, to the user device via the communication channel, at least one of the portion of content, the time-localized metadata, attribute information and mapping information, based at least in part on the reconstruction mode.

19. The computer-readable medium of claim 18, wherein the reconstruction mode is a first reconstruction mode, in which the time-localized metadata is reconstructed by the user device, or a second reconstruction mode, in which the time-localized metadata is reconstructed by a content provider system.

20. The computer-readable medium of claim 17, wherein the sequences of instructions further include instructions, which, when executed by the processor, cause the processor to perform:
retrieving, from an attribute database, attribute information;
retrieving, from a mapping database, mapping information; and
transmitting, to the user device via the communication channel, at least one of the attribute information and mapping information.

21. The computer-readable medium of claim 20, wherein the mapping information associates the portion of content with at least a portion of the attribute information.

22. The computer-readable medium of claim 17, wherein the tag mode is a first tag mode, in which time-localized metadata corresponding to the portion of content is stored within the portion of content, or a second tag mode, in which at least a portion of the time-localized metadata is stored separately from the portion of content.

23. The computer-readable medium of claim 17, wherein the time-localized metadata includes at least one of a tag identifier, an attribute, a start time, and an end time.

24. The computer-readable medium of claim 17, wherein the first database and the second database are the same database.
